(19) United States
(12) Patent Application Publication
(10) Pub. No.: US 2023/0223183 A1
(43) Pub. Date: Jul. 13, 2023

(54) COIL COMPONENT

(71) Applicant: TDK CORPORATION, Tokyo (JP)

(72) Inventors: Yusuke NAGAI, Tokyo (JP); Kazuhiro EBINA, Tokyo (JP); Kunihiko KAWASAKI, Tokyo (JP); Shinichi KONDO, Tokyo (JP); Shinichi SATO, Tokyo (JP); Seiichi NAKAGAWA, Tokyo (JP); Mitsuharu KOIKE, Tokyo (JP); Takato SASAKI, Tokyo (JP); Youhei IIDA, Tokyo (JP)

(73) Assignee: TDK CORPORATION, Tokyo (JP)

(21) Appl. No.: 18/082,689

(22) Filed: Dec. 16, 2022

(30) Foreign Application Priority Data
Jan. 11, 2022 (JP) 2022-002114

(51) Int. Cl. H01F 27/29; H01F 27/255; H01F 27/28

(52) U.S. Cl. CPC H01F 27/29; H01F 27/255; H01F 27/2804; H01F 2027/2809

(57) ABSTRACT

The coil component includes an element body, a coil, a first electrode part and a second electrode part. The element body includes a main surface to be used as a mounting surface. The coil is disposed in the element body. The first electrode part and the second electrode part are spaced apart from each other in a first direction, embedded in the element body in such a way as to be exposed from the main surface, and electrically connected to the coil. The first electrode part includes a first surface exposed from the main surface and a protrusion disposed in the element body in such a way as to be spaced apart from the main surface. The protrusion protrudes more toward the second electrode part than the first surface in the first direction.

### TECHNICAL FIELD

The present disclosure relates to a coil component. This application is based upon and claims the benefit of priority from Japanese Patent Application No. 2022-002114, filed on Jan. 11, 2022, the entire contents of which are incorporated herein by reference.

### BACKGROUND

Japanese Patent Laid-Open No. 2009-206110 discloses a multilayer inductor including a laminate, a conductor pattern spirally formed in the laminate, and a pair of terminal electrodes formed at both ends of a mounting surface of the laminate. The pair of terminal electrodes are connected to the wiring pattern of the mounting substrate.

### SUMMARY

In the laminated inductor disclosed in Japanese Patent Laid-Open No. 2009-206110, the terminal electrode may be peeled off due to bending of the mounting substrate and application of bending stress to the terminal electrode.

A purpose of the present disclosure is to provide a coil component capable of suppressing peeling of an electrode portion.

A coil component according to an aspect of the present disclosure includes an element body, a coil, a first electrode part and a second electrode part. The element body includes a main surface to be used as a mounting surface. The coil is disposed in the element body. The first electrode part and the second electrode part are spaced apart from each other in a first direction, embedded in the element body in such a way as to be exposed from the main surface, and electrically connected to the coil. The first electrode part includes a first surface exposed from the main surface and a protrusion disposed in the element body in such a way as to be spaced apart from the main surface. The protrusion protrudes more toward the second electrode part than the first surface in the first direction.

In the coil component according to the aspect of the present disclosure, the first electrode part includes the protrusion disposed in the element body in such a way as to be spaced apart from the main surface. Since the protrusion functions as an anchor, peeling of the first electrode part is suppressed.

A glass content of the first electrode part may be 20% or less. In this case, since the glass content of the first electrode part is low, the first electrode part is more easily stretched than the element body and is less likely to be broken by stress. Therefore, when a bending stress is applied to the first electrode part, the stress is concentrated between the element body and the first electrode part, and a shear stress is generated. As a result, cracks are likely to occur in the element body starting from the interface between the element body and the first electrode part. Since the protrusion of the first electrode part disperses the shear stress caused by bending, it is possible to suppress the occurrence of cracks in the element body.

The first electrode part may be a plating conductor. In this case, the first electrode part is more easily stretched than the element body and is less likely to be broken by stress. Therefore, when a bending stress is applied to the first electrode part, the stress is concentrated between the element body and the first electrode part, and a shear stress is generated. As a result, cracks are likely to occur in the element body starting from the interface between the element body and the first electrode part. Since the protrusion of the first electrode part disperses the shear stress caused by bending, it is possible to suppress the occurrence of cracks in the element body.

The first electrode part may include a second surface facing away from the first surface and joined to the element body. A surface roughness of the second surface may be greater than a surface roughness of the first surface. In this case, since the joined area between the element body and the first electrode part increases as compared with the configuration in which the surface roughness of the second surface is small, peeling of the first electrode part is further suppressed.

The element body may include a plurality of soft magnetic metal particles. In this case, the first electrode part to the shape of the plurality of soft magnetic metal particles is likely to be formed in the first electrode part. Accordingly, since the joined area between the element body and the first electrode part increases, the peeling of the first electrode part is further suppressed.

A length of the first electrode part in the second direction orthogonal to the main surface may be 5% or more and 40% or less of a length of the element body in the second direction. In this case, by setting the ratio to 5% or more, the joined area between the element body and the first electrode part increases, so that the peeling of the first electrode part is further suppressed. By setting the ratio to 40% or less, the withstand voltage is higher than the voltage generated between the first electrode part and the second electrode part during actual use.

### BRIEF DESCRIPTION OF THE DRAWINGS

FIG. 1 is a perspective view illustrating a coil component according to an embodiment.

FIG. 2 is an exploded perspective view of the coil component shown in FIG. 1.

FIG. 3 is a cross-sectional view of the coil component shown in FIG. 1.

FIG. 4 is a partially enlarged view of FIG. 3.

### DETAILED DESCRIPTION

Hereinafter, embodiments will be described in detail with reference to the accompanying drawings. In the description of the drawings, the same or corresponding elements are denoted by the same reference numerals, and redundant description is omitted.

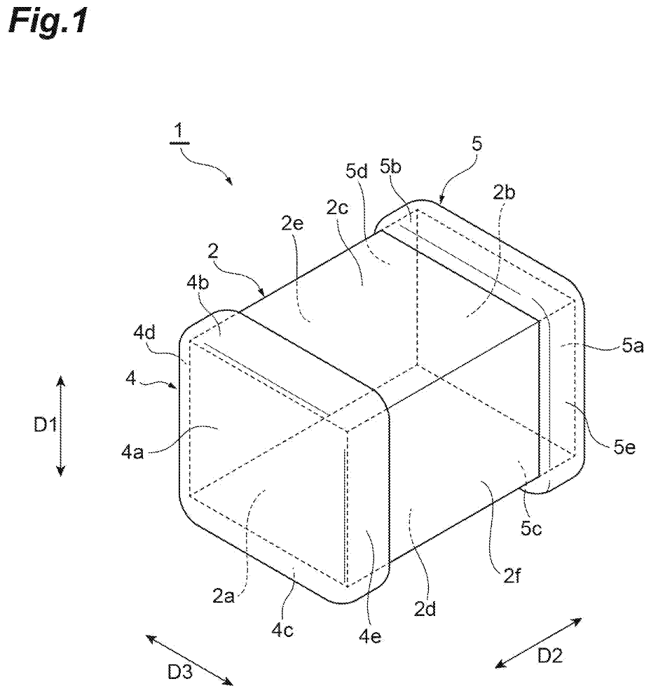

As shown in FIG. 1, a coil component 1 according to the embodiment includes an element body 2, a first external electrode 4, and a second external electrode 5.

The element body 2 has a substantially rectangular parallelepiped shape. The rectangular parallelepiped shape includes a rectangular parallelepiped shape in which corner portions and ridge portions are chamfered and a rectangular parallelepiped shape in which corner portions and ridge portions are rounded. The element body 2 has, as its outer surface, a pair of end surfaces 2a and 2b opposing each other, a pair of main surfaces 2c and 2d opposing each other, and a pair of side surfaces 2e and 2f opposing each other. An opposing direction in which the pair of main surfaces 2c and 2d are opposed to each other is a first direction D1. An opposing direction in which the pair of end surfaces 2a and 2b are opposed to each other is a second direction D2. An opposing direction in which the pair of side surfaces 2e and 2f are opposed to each other is a third direction D3. In the present embodiment, the first direction D1 is a height direction of the element body 2. The second direction D2 is a longitudinal direction of the element body 2 and is orthogonal to the first direction D1. The third direction D3 is a width direction of the element body 2 and is orthogonal to the first direction D1 and the second direction D2.

The pair of end surfaces 2a and 2b extends in the first direction D1 so as to connect between the pair of main surfaces 2c and 2d. The pair of end surfaces 2a and 2b also extends in the third direction D3 (short side direction of the pair of main surfaces 2c and 2d). The pair of end surfaces 2a and 2b are adjacent to the main surface 2d. The pair of side surfaces 2e and 2f extends in the first direction D1 so as to connect between the pair of main surfaces 2c and 2d. The pair of side surfaces 2e and 2f also extends in the second direction D2 (long side direction of the pair of end surfaces 2a and 2b). The main surface 2d may be defined as a mounting surface that faces another electronic device (for example, a circuit board or an electronic component) when the coil component 1 is mounted on the other electronic device. The coil component 1 is connected to other electronic devices by, for example, solder.

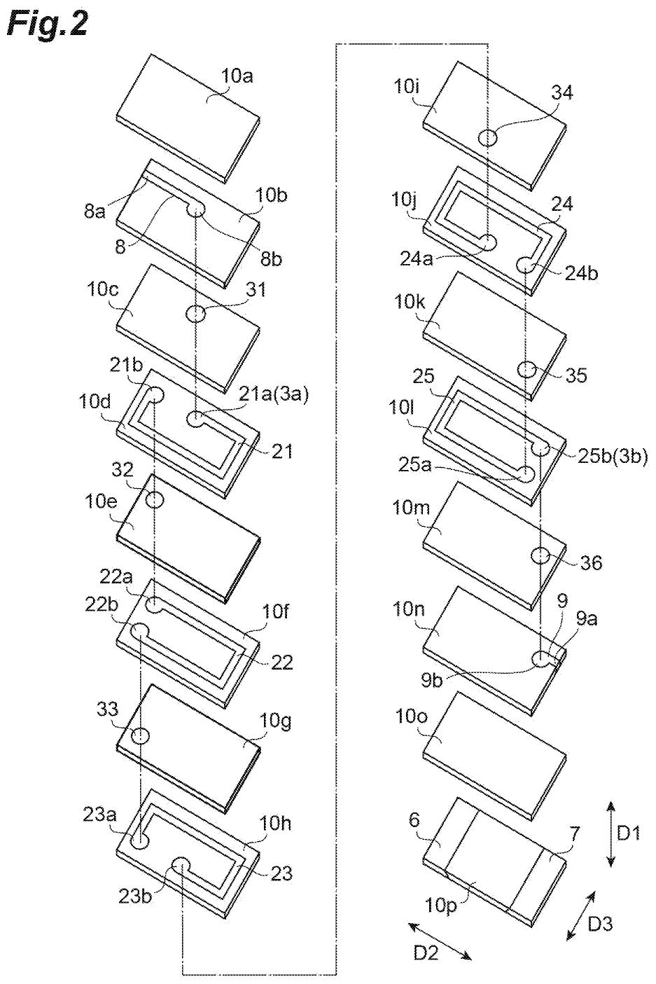

As shown in FIG. 2, the element body 2 has a plurality of element body layers 10a to 10p that are laminated in the first direction D1. The coil component 1 is a multilayer coil component. Each of the element body layers 10a to 10p is laminated in this order in the first direction D1. That is, the first direction D1 is the laminating direction. In the actual element body 2, the element body layers 10a to 10p are integrated to such an extent that the boundary between the layers cannot be visually recognized. In FIG. 2, each of the element body layer 10a to 10p is illustrated one by one, but a plurality of element body layers 10a and a plurality of element body layers 10o are laminated. The main surface 2c is constituted by the main surface of the element body layer 10a located at the laminated end. The main surface 2d is constituted by the main surface of the element body layer 10p.

The thicknesses of each element body layer 10a to 10p (lengths of the first direction D1) are, for example, 1 μm or more 200 μm or less. In FIG. 2, the thicknesses of the element body layers 10a to 10p are shown to be equal, but the element body layers 10b, 10d, 10f, 10h, 10j, 10l, and 10n are thicker than the element body layers 10c, 10e, 10g, 10i, 10k, 10m, and 10o. The coil conductors 21 to 25, a first connection conductor 8, and a second connection conductor 9 described later are provided in the element body layers 10b, 10d, 10f, 10h, 10j, 10l, and 10n. The through-hole conductors 31 to 36 described later are provided in the element body layers 10c, 10e, 10g, 10i, 10k, 10m, and 10o. The thicknesses of the element body layers 10b, 10d, 10f, 10h, 10j, 10l, and 10n are equal to each other in the present embodiment and are, for example, 5 μm or more 200 μm or less. The thicknesses of the element body layers 10c, 10e, 10g, 10i, 10k, 10m, and 10o are equal to each other in the present embodiment and are, for example, 1 μm or more 15 μm or less.

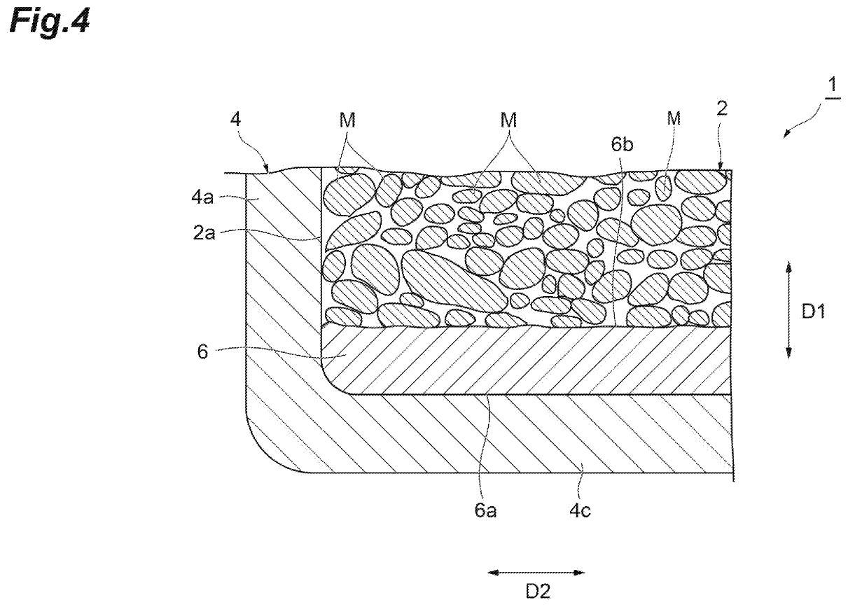

Each of the element body layers 10a to 10p includes a plurality of soft magnetic metal particles M (see FIG. 4). The soft magnetic metal particles M is made of a soft magnetic alloy (soft magnetic material). The soft magnetic alloy is, for example, an Fe—Si-based alloy. When the soft magnetic alloy is the Fe—Si-based alloy, the soft magnetic alloy may contain P. The soft magnetic alloy may be, for example, an Fe—Ni—Si-M-based alloy. “M” includes one or more elements selected from Co, Cr, Mn, P, Ti, Zr, Hf, Nb, Ta, Mo, Mg, Ca, Sr, Ba, Zn, B, Al, and rare earth elements.

The soft magnetic metal particles M are coupled to each other in each of the element body layers 10a to 10p. The coupling between the soft magnetic metal particles M is realized by coupling between oxide films formed on surfaces of the soft magnetic metal particles M, for example. The soft magnetic metal particles M are electrically insulated from each other by coupling of oxide films in each of the element body layers 10a to 10p. The thicknesses of the oxide films are, for example, 5 nm or more 60 nm or less. The oxide film may include one or more layers.

The element body 2 contains resins. The resins are present between the plurality of soft magnetic metal particles M. The resin is an insulating resin having electrical insulating properties. The insulating resin includes, for example, silicone resin, phenol resin, acrylic resin, or epoxy resin.

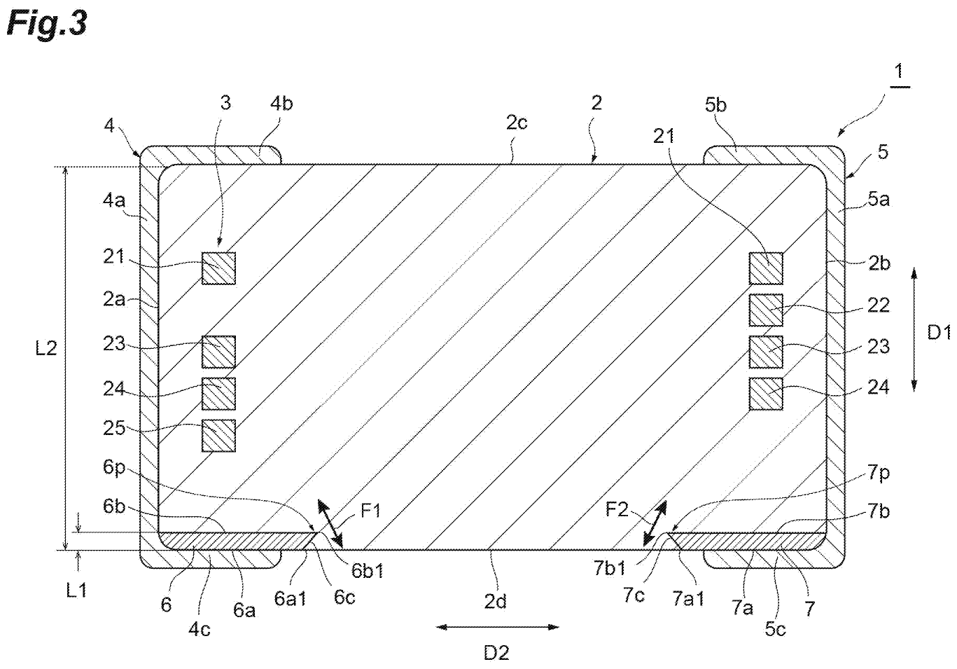

As shown in FIG. 3, in the element body 2, a part of the main surface 2d forms steps. To be specific, a portion close to each of the end surfaces 2a and the end surface 2b is recessed more toward the main surface 2c than the central portion in the main surface 2d.

As shown in FIGS. 1 and 3, the first external electrode 4 and the second external electrode 5 are disposed on the element body 2. The first external electrode 4 and the second external electrode 5 are disposed on an outer surface of the element body 2. The first external electrode 4 is located at one end portion of the second direction D2 of the element body 2. The second external electrode 5 is located at the other end portion of the second direction D2 of the element body 2. The first external electrode 4 and the second external electrode 5 are spaced apart from each other in the second direction D2.

The first external electrode 4 includes a first electrode portion 4a located on the end surface 2a, a second electrode portion 4b located on the main surface 2c, a third electrode portion 4c located on the main surface 2d, a fourth electrode portion 4d located on the side surface 2e, and a fifth electrode portion 4e located on a side surface 2f. The first electrode portion 4a extends along the first direction D1 and the third direction D3 and has a rectangular shape when viewed from the second direction D2. The second electrode portion 4b extends along the second direction D2 and the third direction D3 and has a rectangular shape when viewed from the first direction D1. The third electrode portion 4c extends along the second direction D2 and the third direction D3 and has a rectangular shape when viewed from the first direction D1. The fourth electrode portion 4d extends along the first direction D1 and the second direction D2 and has a rectangular shape when viewed from the third direction D3. The fifth electrode portion 4e extends along the first direction D1 and the second direction D2 and has a rectangular shape when viewed from the third direction D3.

The first electrode portion 4a, the second electrode portion 4b, the third electrode portion 4c, the fourth electrode portion 4d, and the fifth electrode portion 4e are connected at the ridges of the element body 2, and are electrically connected to each other. The first external electrode 4 is formed on five surfaces that include the end surface 2a, the pair of main surfaces 2c and 2d, and the pair of side surfaces 2e and 2f. The first electrode portion 4a, the second electrode portion 4b, the third electrode portion 4c, the fourth electrode portion 4d, and the fifth electrode portion 4e are integrally formed.

The second external electrode 5 includes a first electrode portion 5a located on the end surface 2b, a second electrode portion 5b located on the main surface 2c, a third electrode portion 5c located on the main surface 2d, a fourth electrode portion 5d located on the side surface 2e, and a fifth electrode portion 5e located on the side surface 2f. The first electrode portion 5a extends along the first direction D1 and the third direction D3 and has a rectangular shape when viewed from the second direction D2. The second electrode portion 5b extends along the second direction D2 and the third direction D3 and has a rectangular shape when viewed from the first direction D1. The third electrode portion 5c extends along the second direction D2 and the third direction D3 and has a rectangular shape when viewed from the first direction D1. The fourth electrode portion 5d extends along the first direction D1 and the second direction D2 and has a rectangular shape when viewed from the third direction D3. The fifth electrode portion 5e extends along the first direction D1 and the second direction D2 and has a rectangular shape when viewed from the third direction D3.

The first electrode portion 5a, the second electrode portion 5b, the third electrode portion 5c, the fourth electrode portion 5d, and the fifth electrode portion 5e are connected at the ridges of the element body 2, and are electrically connected to each other. The second external electrode 5 are formed on five surfaces that include the end surface 2b, the pair of main surfaces 2c and 2d, and the pair of side surfaces 2e and 2f. The first electrode portion 5a, the second electrode portion 5b, the third electrode portion 5c, the fourth electrode portion 5d, and the fifth electrode portion 5e are integrally formed.

The first external electrode 4 and the second external electrode 5 may be conductive resin layers. As the conductive resin, a thermosetting resin mixed with a conductive material, an organic solvent and the like is used. As the conductive material, for example, a conductive filler is used. The conductive filler is a metal powder. As the metal powder, for example, Ag powder is used. As the thermosetting resin, for example, a phenol resin or an epoxy resin is used.

As shown in FIGS. 2 and 3, the coil component 1 further includes a first electrode part 6 and a second electrode part 7. The first electrode part 6 and the second electrode part 7 are spaced apart from each other in the second direction D2 and are embedded in the element body 2 in such a way as to be exposed from the main surface 2d. The first electrode part 6 is provided so as to fill a step provided on the end surface 2a side of the main surface 2d. The second electrode part 7 is provided so as to fill a step provided on the end surface 2b side of the main surface 2d. The first electrode part 6 and the second electrode part 7 are electrically connected to a coil 3 described later. The first electrode part 6 is electrically connected to the first external electrode 4. The second electrode part 7 is electrically connected to the second external electrode 5.

The first electrode part 6 and the second electrode part 7 are provided so as to sandwich the element body layer 10p in the second direction D2. The length L1 (thickness) in the first direction D1 of each of the first electrode part 6 and the second electrode part 7 is equal to the length in the first direction D1 of the element body layer 10p, and is, for example, 5 μm or more and 50 μm or less. The length L1 is 5% or more and 40% or less of the length L2 in the first direction D1 of the element body 2. The length L2 is 50 μm or more and 1600 μm or less, for example. The length L2 may be, for example, 50 μm or more and 400 μm or less. The first electrode part 6 and the second electrode part 7 are, for example, printing pastes or plating conductors. The first electrode part 6 and the second electrode part 7 contain a conductive material. The conductive material is, for example, Ag, Pd, Cu, Pt, or Ni.

In the case of a printing paste, the conductive material may be, for example, Al. A glass content of the first electrode part 6 and the second electrode part 7 is 20% or less. The first electrode part 6 and the second electrode part 7 are less likely to be destroyed by stresses than the element body 2.

The first electrode part 6 includes a first surface 6a exposed from the element body 2 and a second surface 6b and a third surface 6c. The second surface 6b and the third surface 6c are disposed in the element body 2 and joined to the element body 2. The first surface 6a is exposed from the main surface 2d. The length of the first surface 6a in the third direction D3 is equivalent to the length of the main surface 2d in the third direction D3. The first surface 6a has a rectangular shape when viewed from the first direction D1. The first surface 6a forms the same plane as the main surface 2d and is connected to the main surface 2d in the same plane. The first surface 6a is connected to each of the end surface 2a, the side surface 2e, and the side surface 2f in the same plane. The first surface 6a is covered with the third electrode portion 4c and joined to the third electrode portion 4c. An end region of the first surface 6a is exposed from the third electrode portion 4c. The end region includes an end 6a1 of the first surface 6a. The end 6a1 is close to the end surface 2b.

The second surface 6b is opposed to the first surface 6a in the first direction D1. The second surface 6b is provided substantially parallel to the main surface 2d. The second surface 6b has a rectangular shape when viewed from the first direction D1. The length of the second surface 6b in the third direction D3 is equivalent to the length of the main surface 2d in the third direction D3. When viewed from the first direction D1, the area of the second surface 6b is larger than the area of the first surface 6a. The length of the second surface 6b in the second direction D2 is longer than the length of the first surface 6a in the second direction D2.

The third surface 6c connects the end 6a1 of the first surface 6a on the end surface 2b side and the end 6b1 of the second surface 6b on the end surface 2b side. The end 6a1 is located closer to the end surface 2a than the end 6b1 in the second direction D2. The third surface 6c is an inclined surface inclined with respect to the first direction D1. When viewed form the third direction D3, the angle between the third surface 6c and the first surface 6a is an obtuse angle, and the angle between the third surface 6c and the second surface 6b is an acute angle. When viewed form the first direction D1, the entire the third surface 6c overlaps the second surface 6b.

The first electrode part 6 includes a protrusion 6p. The protrusion 6p is disposed in the element body 2 in such a way as to space away from the main surface 2d. The protrusion 6p protrudes more toward the second electrode part 7 than the first surface 6a in the second direction D2. The protrusion 6p is constituted by an acute-angled ridge portion formed by the second surface 6b and the third surface 6c. When viewed from the third direction D3, the protrusion 6p has a tapered shape. The length of the protrusion 6p in the first direction D1 decreases toward the second electrode part 7.

The second electrode part 7 includes a first surface 7a exposed from the element body 2 and a second surface 7b and a third surface 7c. The second surface 7b and the third surface 7c are disposed in the element body 2 and joined to the element body 2. The first surface 7a is exposed from the main surface 2d. The length of the first surface 7a in the third direction D3 is equivalent to the length of the main surface 2d in the third direction D3. The first surface 7a has a rectangular shape when viewed from the first direction D1. The first surface 7a forms the same plane as the main surface 2d and is connected to the main surface 2d in the same plane. The first surface 7a is connected to each of the end surface 2b, the side surface 2e, and the side surface 2f in the same plane. The first surface 7a is covered with the third electrode portion 5c and joined to the third electrode portion 5c. An end region of the first surface 7a is exposed from the third electrode portion 5c. The end region includes an end 7a1 of the first surface 7a. The end 7a1 is close to the end surface 2a.

The second surface 7b is opposed to the first surface 7a in the first direction D1. The second surface 7b is provided substantially parallel to the main surface 2d. The second surface 7b has a rectangular shape when viewed from the first direction D1. The length of the second surface 7b in the third direction D3 is equivalent to the length of the main surface 2d in the third direction D3. When viewed form the first direction D1, the area of the second surface 7b is larger than the area of the first surface 7a. The length of the second surface 7b in the second direction D2 is longer than the length of the first surface 7a in the second direction D2.

The third surface 7c connects the end 7a1 of the first surface 7a on the end surface 2a side and the end 7b1 of the second surface 7b on the end surface 2a side. The end 7a1 is located closer to the end surface 2b than the end 7b1 in the second direction D2. The third surface 7c is an inclined surface inclined with respect to the first direction D1. When viewed form the third direction D3, the angle between the third surface 7c and the first surface 7a is an obtuse angle, and the angle between the third surface 7c and the second surface 7b is an acute angle. When viewed form the first direction D1, the entire the third surface 7c overlaps the second surface 7b.

The second electrode part 7 includes a protrusion 7p. The protrusion 7p is disposed in the element body 2 in such a way as to space away from the main surface 2d. The protrusion 7p protrudes more toward the first electrode part 6 than the first surface 7a in the second direction D2. The protrusion 7p is constituted by an acute-angled ridge portion formed by the second surface 7b and the third surface 7c. When viewed from the third direction D3, the protrusion 7p has a tapered shape. The length of the protrusion 7p in the first direction D1 decreases toward the first electrode part 6.

As shown in FIG. 4, the roughness (arithmetic average roughness Ra) of the second surface 6b is larger than the roughness (arithmetic average roughness Ra) of the first surface 6a. The roughness of the second surface 6b is 1.1 times or more and 10 times or less that of the first surface 6a. The second surface 6b is formed along the surface shape of the element body 2. The element body 2 has an uneven shape due to a plurality of the soft magnetic metal particles M contained in the element body 2. The second surface 6b has a shape that reflects this uneven shape. The first surface 6a is a flat surface.

Although not shown, the first surface 7a of the second electrode part 7 has a shape similar to that of the first surface 6a of the first electrode part 6, and the second surface 7b of the second electrode part 7 has a shape similar to that of the second surface 6b of the first electrode part 6. That is, the roughness (arithmetic average roughness Ra) of the second surface 7b is also larger than the roughness (arithmetic average roughness Ra) of the first surface 7a. The roughness of the second surface 7b is 1.1 times or more and 10 times or less that of the first surface 7a. As described later, on manufacturing the coil component 1, conductor patterns which will be the first electrode part 6 and the second electrode part 7 are laminated together with green sheets which will be a plurality of element body layers 10a to 10p, and pressed in a laminating direction. As a result, an uneven shape corresponding to the shape of the plurality of the soft magnetic metal particles M is formed on the second surfaces 6b and 7b.

As shown in FIGS. 2 and 3, the coil component 1 further includes a coil 3, a first connection conductor 8, and a second connection conductor 9.

The coil 3 is disposed in the element body 2. The coil 3 is spaced apart from the outer surface of the element body 2. In the present embodiment, the coil 3 is disposed at the center of the element body 2 in the second direction D2 and the third direction D3. In other words, a separation distance between the coil 3 and the end surface 2a is equal to a separation distance between the coil 3 and the end surface 2b. A separation distance between the coil 3 and the side surface 2e is equal to a separation distance between the coil 3 and the side surface 2f.

The coil 3 includes coil conductors 21 to 25 and through-hole conductors 31 to 36 which are electrically connected to each other. The coil conductors 21 to 25 and the through-hole conductors 31 to 36 are inner conductors disposed inside the coil 3 together with the first connection conductor 8 and the second connection conductor 9. The internal conductor is, for example, a printing paste or a plated conductor. The inner conductor includes an electrically conductive material. The conductive material is, for example, Ag, Pd, Cu, Al, or Ni. The inner conductors are made of the same material, for example. The inner conductor is made of, for example, the same material as the first electrode part 6 and the second electrode part 7.

The coil axes of the coils 3 are provided along the first direction D1. The coil conductors 21 to 25 are arranged so as to at least partially overlap each other when viewed from the first direction D1. One end portion 21a of a coil conductor 21 constitutes one end portion 3a of the coil 3. The other end portion 21b of the coil conductor 21 is connected by a through-hole conductor 32 to one end portion 22a of a coil conductor 22. The other end portion 22b of the coil conductor 22 is connected by a through-hole conductor 33 to one end portion 23a of a coil conductor 23. The other end portion 23b of the coil conductor 23 is connected by a through-hole conductor 34 to one end portion 24a of a coil conductor 24. The other end portion 24b of the coil conductor 24 is connected by a through-hole conductor 35 to one end portion 25a of a coil conductor 25. The other end portion 25b of the coil conductor 25 constitutes the other end portion 3b of the coil 3.

Each of the end portions 21a to 25a and 21b to 25b of the coil conductors 21 to 25 is formed in a circular shape when viewed from the first direction D1. When viewed from the first direction D1, the diameter of each end portion 21a to 25a and 21b to 25b is greater than a line width of each coil conductor 21 to 25. The line width is line widths of the portions other than the end portions 21a to 25a and 21b to 25b of the coil conductors 21 to 25. Since each end portion 21a to 25a and 21b to 25b is enlarged, the end portions 21a to 25a and 21b to 25b can be easily connected to the through-hole conductors 31 to 36. The diameter of each end portion 21a to 25a and 21b to 25b is equivalent to the diameters of each through-hole conductor 31 to 36.

The coil conductor 21 is provided on the element body layer 10d. The coil conductor 22 is provided on the element body layer 10f. The coil conductor 23 is provided on the element body layer 10h. The coil conductor 24 is provided on the element body layer 10j. The coil conductor 25 is provided on the element body layer 10l. The coil conductors 21 to 25 are provided so as to pass through the corresponding element body layer 10d, 10f, 10h, 10j, and 10l in the thickness direction (that is, the first direction D1) thereof. The coil conductor 21 is arranged closest to the main surface 2c among the coil conductors 21 to 25. The coil conductor 25 is arranged closest to the main surface 2d among the coil conductors 21 to 25.

The lengths of the coil conductors 21 to 25 in the first direction D1 are equal to each other in present embodiment. The lengths of the coil conductors 21 to 25 in the first direction D1 are equivalent to the thicknesses of the corresponding element body layer 10d, 10f, 10h, 10j and 10l.

The through-hole conductor 31 is provided on the element body layer 10c. The through-hole conductor 32 is provided on the element body layer 10e. The through-hole conductor 33 is provided on the element body layer 10g. The through-hole conductor 34 is provided on the element body layer 10i. The through-hole conductor 35 is provided on the element body layer 10k. The through-hole conductor 36 is provided on the element body layer 10m. Each of the through-hole conductors 31 to 36 is provided so as to pass through the corresponding element body layer 10c, 10e, 10g, 10i, 10k, and 10m in the thickness direction (that is, the first direction D1) thereof.

The lengths of the through-hole conductors 31 to 36 in the first direction D1 are equal to each other in present embodiment. The lengths of the through-hole conductors 31 to 36 in the first direction D1 are equal to the thicknesses of the corresponding element body layers 10c, 10e, 10g, 10i, 10k, and 10m.

The first connection conductor 8 connects one end portion 3a of the coil 3 to the first electrode portion 4a of the first external electrode 4. The coil conductor 21 including the end portion 3a has the same potential as the first external electrode 4. The first connection conductor 8 extends in the second direction D2. The first connection conductor 8 has a first end portion 8a and a second end portion 8b. The first end portion 8a is exposed from the end surface 2a and connected to the first electrode portion 4a.

The second end portion 8b is connected to one end portion 3a of the coil 3 by the through-hole conductor 31. The second end portion 8b is formed in a circular shape when viewed from the first direction D1.

As viewed from the first direction D1, the diameter of the second end portion 8b is greater than the line widths of portions other than both end portions 8a and 8b of the first connection conductor 8. Since the second end portion 8b is enlarged in this manner, the second end portion 8b and the through-hole conductor 31 are easily connected.

The second connection conductor 9 connects the other end portion 3b of the coil 3 and the first electrode portion 5a of the second external electrode 5. The coil conductor 25 including the end portion 3b has the same potential as the second external electrode 5. The second connection conductor 9 extends in the second direction D2. The second connection conductor 9 has a first end portion 9a and a second end portion 9b. The first end portion 9a is exposed from the end surface 2b and connected to the first electrode portion 5a.

The second end portion 9b is connected to the other end portion 3b of the coil 3 by the through-hole conductor 36. The second end portion 9b is formed in a circular shape when viewed from the first direction D1. As viewed from the first direction D1, the diameter of the second end portion 9b is greater than the line widths of portions other than both end portions 9a and 9b of the second connection conductor 9. Since the second end portion 9b is enlarged in this manner, the second end portion 9b and the through-hole conductor 36 are easily connected.

Next, a method of manufacturing the coil component 1 will be described.

The soft magnetic metal particles M, insulating resins, solvents and the like are mixed to prepare slurry. The prepared slurry is provided on a base material (for example, a polyethylene terephthalate film) by, for example, a screen printing method or a doctor-blade method to form a plurality of green sheets serving as the plurality of element body layers 10a on the base material. Similarly, a plurality of green sheets serving as the plurality of element body layers 10o is formed on the base material.

A conductor pattern to be the first connection conductor 8 is formed on a base material by screen printing or plating. Subsequently, the slurry is applied onto the base material by, for example, the screen printing method so as to fill the periphery of the conductor pattern. Thus, a plurality of green sheets serving as the plurality of element body layers 10b is formed on the base material. A plurality of green sheets which becomes the plurality of element body layers 10c to 10n and 10p is also formed so as to fill the periphery after forming the corresponding conductor pattern on a base material.

Next, green sheets to be element body layers 10a to 10p are transferred and laminated together with the conductor pattern in this order. The green sheets are pressed from the laminating direction to form a laminate. Subsequently, the laminate of the green sheets is fired to form a laminate substrate. Subsequently, the laminate substrate is cut into chips of a predetermined size by a cutting machine including a rotary blade to form individualized laminates. Next, the corner portions and ridge portions of the laminate are chamfered by barrel polishing.

Subsequently, the laminate is immersed in a resin solution to impregnate the laminate with the resin. Thus, the element body 2 is formed. Next, resin electrode layers serving as the first external electrode 4 and the second external electrode 5 are formed on both end portions of the element body 2 by, for example, a dipping method. As described above, the coil component 1 is formed.

As described above, the coil component 1 includes the first electrode part 6 and the second electrode part 7 exposed from the main surface 2d that is used as the mounting surface. The first electrode part 6 and the second electrode part 7 have the protrusions 6p and 7p, respectively, disposed in the element body 2 in such a way as to space apart from the main surface 2d. Since the protrusions 6p and 7p function as anchors, the first electrode part 6 and the second electrode part 7 are prevented from peeling off or falling off from the element body 2.

The coil component 1 is mounted on the other electronic device. The first electrode part 6 and the second electrode part 7 together with the first external electrode 4 and the second external electrode 5 are connected to a mounting electrode of the other electronic device by soldering, for example. When the other electronic device is bent with the coil component 1 mounted on the other electronic device, bending stresses are applied to the first electrode part 6 and the second electrode part 7. The glass content of each of the first electrode part 6 and the second electrode part 7 is 20% or less. Since the first electrode part 6 and the second electrode part 7 have a low glass content, they are more easily stretched than the element body 2 and are less likely to be broken by stresses. Thus, when bending stresses are applied to the first electrode part 6 and the second electrode part 7, the stresses are concentrated between the element body 2 and each of the first electrode part 6 and the second electrode part 7 and shear stresses F1 and F2 are generated as shown in FIG. 3.

When the interface between the first electrode part 6 and the element body 2 extends in a direction along the shear stress F1, cracks are likely to occur in the element body 2 starting from the interface. The third surface 6c of the first electrode part 6 extends in a direction generally perpendicular to the shear stress F1. Therefore, the interface between the third surface 6c and the element body 2 is less likely to be a starting point of cracks in the element body 2. Further, since the protrusion 6p disperses the shear stress F1, occurrence of cracks in the element body 2 is suppressed. Therefore, the inner conductor is less likely to be affected by cracks.

When the interface between the second electrode part 7 and the element body 2 extends in a direction along the shear stress F2, cracks are likely to occur in the element body 2 starting from the interface. The third surface 7c of the second electrode part 7 extends in a direction generally perpendicular to the shear stress F2. Therefore, the interface between the third surface 7c and the element body 2 is less likely to be a starting point of cracks in the element body 2. Further, since the protrusion 7p disperses the shear stress F2, occurrence of cracks in the element body 2 is suppressed. Therefore, the inner conductor is less likely to be affected by cracks.

When the first electrode part 6 and the second electrode part 7 are plating conductors, the first electrode part 6 and the second electrode part 7 stretch more easily than the element body 2 and are less likely to be destroyed by stresses. Thus, when bending stresses are applied to the first electrode part 6 and the second electrode part 7, the stresses are concentrated between the element body 2 and each of the first electrode part 6 and the second electrode part 7 and shear stresses are generated. As a result, cracks are likely to occur in the element body 2 starting from the interface between the element body 2 and each of the first electrode part 6 and the second electrode part 7. Even in this case, since the protrusions 6p and 7p disperse the shear stresses F1 and F2 due to bending, it is possible to suppress the occurrence of cracks in the element body 2.

In the first electrode part 6, the roughness of the second surface 6b is greater than that of the first surface 6a. Since the joined area between the element body 2 and the first electrode part 6 increases as compared with a configuration in which the roughness of the second surface 6b is small, peeling of the first electrode part 6 is further suppressed. In the second electrode part 7, the roughness of the second surface 7b is greater than that of the first surface 7a. Since the joined area between the element body 2 and the second electrode part 7 increases as compared with a configuration in which the roughness of the second surface 7b is small, peeling of the second electrode part 7 is further suppressed.

The element body 2 includes a plurality of the soft magnetic metal particles M. For this reason, the uneven shape corresponding to the shape of a plurality of the soft magnetic metal particles M is easily formed in the second surface 6b of the first electrode part 6 and the second surface 7b of the second electrode part 7. As a result, the joined area between the element body 2 and the first electrode part 6 increases. Accordingly, peeling of the first electrode part 6 is further suppressed. Since the joined area between the element body 2 and the second electrode part 7 increases. Accordingly, peeling of the second electrode part 7 is further suppressed.

The length L1 of each of the first electrode part 6 and the second electrode part 7 is 5% or more and 40% or less of the length L2 of the element body 2. When the ratio is 5% or more, the joined area between the element body 2 and each of the first electrode part 6 and the second electrode part 7 increases, and thus peeling of the first electrode part 6 and the second electrode part 7 is further suppressed. When the ratio is 40% or less, the withstand voltage is higher than the voltage generated between the first electrode part 6 and the second electrode part 7 during actual use.

Although the embodiments of the present invention have been described above, the present invention is not necessarily limited to the above-described embodiments, and various modifications can be made without departing from the scope of the present invention.

At least one of the first electrode part 6 and the second electrode part 7 may have protrusion 6p or 7p. The protrusions 6p and 7p only need to have a shape that functions as an anchor, and are not limited to the shape of the above embodiment. For example, the protrusions 6p and 7p may have a shape in which the length in the first direction D1 is constant, instead of the tapered shape.

The first electrode part 6 is in contact with each of the end surface 2a, the side surface 2e, and the side surface 2f when viewed from the first direction D1, but may be spaced apart from each of the end surface 2a, the side surface 2e, and the side surface 2f. The second electrode part 7 is in contact with each of the end surface 2b, the side surface 2e, and the side surface 2f when viewed from the first direction D1, but may be spaced apart from each of the end surface 2b, the side surface 2e, and the side surface 2f.

The element body 2 does not necessarily include soft magnetic metal particles, and may be made of ferrite (for example, Ni—Cu—Zn ferrite, Ni—Cu—Zn—Mg ferrite, or Cu—Zn ferrite), a dielectric material, or the like. The coil conductors 21 to 25, the through-hole conductors 31 to 36, the first connection conductor 8, the second connection conductor 9, the first electrode part 6, and the second electrode part 7 may be sintered metal conductors.

The second end portion 8b of the first connection conductor 8, the second end portion 9b of the second connection conductor 9, and the end portions 21a to 25a and 21b to 25b of the coil conductors 21 to 25 are enlarged when viewed from the first direction D1, but may not be enlarged.

The first connection conductor 8 and the coil conductor 21 are disposed on the magnetic layers different from each other, but may be disposed on the same magnetic layer. In this case, the first connection conductor 8 and the coil conductor 21 are directly connected so as to be continuous within the same magnetic layer without the through-hole conductor 31. The second connection conductor 9 and the coil conductor 25 are disposed on the magnetic layers different from each other, but may be disposed on the same magnetic layer. In this case, the second connection conductor 9 and the coil conductor 25 are directly connected so as to be continuous within the same magnetic layer without the through-hole conductor 36.

The first external electrode 4 may not include the second electrode portion 4b. The second external electrode 5 may not include the second electrode portion 5b.

While the first connection conductor 8 is exposed to the end surface 2a and the second connection conductor 9 is exposed to the end surface 2b, the first connection conductor 8 and the second connection conductor 9 may be exposed to the main surface 2d.

1. A coil component comprising:
an element body including a main surface to be used as a mounting surface;
a coil disposed in the element body; and
a first electrode part and a second electrode part spaced apart from each other in a first direction, embedded in the element body in such a way as to be exposed from the main surface, and electrically connected to the coil,
wherein the first electrode part includes a first surface exposed from the main surface and a protrusion disposed in the element body in such a way as to be spaced apart from the main surface, and
the protrusion protrudes more toward the second electrode part than the first surface in the first direction.

2. The coil component according to claim 1, wherein a glass content of the first electrode part is 20% or less.

3. The coil component according to claim 1, wherein
the first electrode part is a plating conductor.

4. The coil component according to claim 1, wherein the first electrode part includes a second surface facing away from the first surface and joined to the element body, and
a surface roughness of the second surface is greater than a surface roughness of the first surface.

5. The coil component according to claim 1, wherein the element body includes a plurality of soft magnetic metal particles.

6. The coil component according to claim 1, wherein a length of the first electrode part in a second direction orthogonal to the main surface is 5% or more and 40% or less of a length of the element body in the second direction.

7. The coil component according to claim 1, wherein the protrusion has a tapered shape.

8. The coil component according to claim 7, wherein a length of the protrusion in a second direction orthogonal to the main surface decreases toward the second electrode part.

9. The coil component according to claim 4, wherein the surface roughness of the second surface is 1.1 times or more and 10 times or less that of the first surface.

10. The coil component according to claim 4, wherein an area of the second surface is larger than an area of the first surface when viewed from a second direction orthogonal to the main surface.

11. The coil component according to claim 1, wherein the second electrode part includes a third surface exposed from the main surface and a protrusion disposed in the element body in such a way as to be spaced apart from the main surface, and
the protrusion of the second electrode part protrudes more toward the first electrode part than the third surface in the first direction.

12. The coil component according to claim 1, wherein the element body includes a plurality of element body layers in a second direction orthogonal to the main surface.

13. The coil component according to claim 12, wherein the plurality of element body layers includes a plurality of soft magnetic metal particles.

14. The coil component according to claim 13, wherein the plurality of element body layers includes a resin that is present between the plurality of soft magnetic metal particles.

15. The coil component according to claim 14, wherein the resin has an electrical insulating property.

16. The coil component according to claim 1, wherein a length in a second direction orthogonal to the main surface is 5 μm or more and 50 μm or less.

17. The coil component according to claim 1, wherein the first surface forms the same plane as the main surface.
